(19) United States
(12) Patent Application Publication
(10) Pub. No.: US 2025/0101323 A1
(43) Pub. Date: Mar. 27, 2025

(54) PRODUCING HYDROCARBONS FROM ORGANIC MATERIAL OF BIOLOGICAL ORIGIN

(71) Applicant: Neste Oyj, Espoo (FI)

(72) Inventors: Thomas BJÖRKLÖF, Porvoo (FI); Petri LINDQVIST, Porvoo (FI)

(73) Assignee: Neste Oyj, Espoo (FI)

(21) Appl. No.: 18/725,393

(22) PCT Filed: Dec. 30, 2022
(86) PCT No.: PCT/FI2022/050883

§ 371 Date: Jun. 28, 2024

(30) Foreign Application Priority Data
Dec. 30, 2021 (FI) 20216368
Dec. 30, 2021 (FI) 20216369
Dec. 30, 2021 (FI) 20216372
Dec. 30, 2021 (FI) 20216374
Dec. 30, 2021 (FI) 20216376

(51) Int. Cl. C10G 69/02; C10G 7/00

(52) U.S. Cl. CPC C10G 69/02; C10G 7/00; C10G 2300/1007; C10G 2300/1014; C10G 2300/202

(57) ABSTRACT

The present disclosure provides a process for producing hydrocarbons from a feedstock containing organic material of biological origin. An exemplary process includes providing a feedstock containing organic material of biological origin; subjecting the feedstock to pre-hydrotreatment, wherein the pre-hydrotreatment is carried out in an ebullated bed reactor, to obtain a partly hydrotreated feed; subjecting the partly hydrotreated feed to hydrotreatment, wherein the hydrotreatment is carried out in a fixed bed reactor, to obtain a stream of hydrocarbons; and subjecting the stream of hydrocarbons to isomerisation to obtain an isomerised stream of hydrocarbons.

### FIELD OF THE INVENTION

The present invention relates to a process of producing hydrocarbons from organic material of biological origin, in particular organic material of biological origin comprising a high amount of impurities, such as nitrogen, silicon, chloride and phosphorous containing compounds, as well as metals. The present process is particularly suitable for challenging feedstock, which would typically not be introduced to a hydrogenation process using sensitive catalysts.

### BACKGROUND OF THE INVENTION

Various oils and fats have been used as feedstock in production of middle distillate components suitable as fuels especially for diesel engines. The purpose of using renewable and recycled organic material of biological origin in production of fuel components is mainly to reduce the use of fossil based feedstock and thereby to tackle global warming and other environmental issues. Hydrogenated vegetable oil (HVO) is a promising alternative to fossil based middle distillate fuels. Although HVO is mainly produced from vegetable oils, also other sources such as animal fats and algae oils can be used. There is still a need for alternative non-fossil based sources and processes to produce especially middle distillate fuels.

Many organic material sources that could be used to produce hydrocarbon components, contain high amounts of impurities such as nitrogen, silicon, chloride and phosphorous containing compounds and metals. These and other impurities weaken the possibility of many organic materials to be used as feedstock or lowers the quality of the products.

Many previous methods have suggested various pre-treatment and purification processes for feedstock contain high amounts of impurities. There is also a need for new over all processes to handle feedstock with high amounts of impurities, as well as other feedstock.

Trickle bed reactors with a fixed catalyst bed are normally used in hydrotreatment of vegetable oils (HVO). The hydrotreatment catalyst used in hydrotreatment is sensitive to various impurities, such as P and metals. Impurities deactivate and block the catalyst, causing incomplete reactions, pressure differences and channeling in the catalyst bed.

### BRIEF DESCRIPTION OF THE INVENTION

An object of the present invention is thus to provide a process as to solve the above problems. The present process is particularly suitable for challenging feedstock. With challenging feedstock is meant herein low-quality feedstock containing e.g. phosphorus and metal impurities, which are difficult to remove by regular pretreatment methods, such as degumming or bleaching, and which cause problems for catalysts, such as deactivation, when used in the subsequent hydrotreatment processes. Moreover, challenging feedstock may include chemically challenging materials like resin acids and unsaponifiable matter included in e.g. crude tall oil.

The objects of the invention are achieved by a process, which is characterized by what is stated in the independent claim. The preferred embodiments of the invention are disclosed in the dependent claims.

The catalyst in an ebullated bed reactor is fluidized by the recycle product together with fresh feed and gaseous hydrogen. The feeds to the reactor are through the bottom, which lifts the catalyst from a grid plate supporting it. Catalyst can be removed from an ebullated bed reactor during operation through a catalyst withdrawal nozzle and make-up catalyst added into the catalyst bed from the top of the reactor. This keeps the catalyst active enough on average despite deactivation of the catalyst.

### DETAILED DESCRIPTION OF THE INVENTION

The present invention provides a process for producing hydrocarbons from a feedstock comprising organic material of biological origin.

As used herein the term “organic material of biological origin” refers to organic material, i.e. material containing carbon. The organic material is of biological origin, i.e. from natural resource such as but not limited to plants, trees, algae, microbes but also animal sources are possible. Organic material of biological origin is here meant to exclude fossil based organic material. Organic material of biological origin as herein used can also be renewable material. The organic material suitable in the present process typically contain organic compounds such as fatty acids, resin and rosin acids and other lipophilic compounds but also other organic compounds.

Waste and residues containing organic material may further be used as feedstock, while containing compounds and/or impurities that are not allowed or just spoiling the usability thereof for e.g. food or feed or cosmetics applications.

The renewable character of carbon-containing compositions, such as feedstocks and products of biological origin i.e. renewable feedstock and products, can be determined by comparing the 14C-isotope content of the feedstock to the 14C-isotope content in the air in 1950. The 14C-isotope content can be used as evidence of the renewable origin of the feedstock or product. Carbon atoms of renewable material comprise a higher number of unstable radiocarbon (14C) atoms compared to carbon atoms of fossil origin. Therefore, it is possible to distinguish between carbon compounds derived from biological sources, and carbon compounds derived from fossil sources by analyzing the ratio of 12C and 14C isotopes. Thus, a particular ratio of said isotopes can be used to identify and quantify renewable carbon compounds and differentiate those from non-renewable i.e. fossil carbon compounds. The isotope ratio does not change in the course of chemical reactions. Examples of a suitable method for analyzing the content of carbon from biological sources is ASTM D6866 (2020). An example of how to apply ASTM D6866 to determine the renewable content in fuels is provided in the article of Dijs et al., Radiocarbon, 48 (3), 2006, pp 315-323. For the purpose of the present invention, a carbon-containing material, such as a feedstock or product is considered to be of renewable origin if it contains 90% or more modern carbon, such as 100% modern carbon, as measured using ASTM D6866.

Particular examples of the feedstock comprising organic material of biological origin of the present invention include, but are not limited to, animal based fats and oils, such as suet, tallow, blubber, lard, train oil, milk fat, fish oil, poultry oil, and poultry fat; plant based fats and oils, such as sludge palm oil, rape-seed oil, canola oil, colza oil, sunflower oil, soybean oil, hemp oil, olive oil, linseed oil, cottonseed oil, mustard oil, palm oil, arachis oil, castor oil, coconut oil, lignocellulosic pyrolysis liquid (LPL), HTL biocrude, crude tall oil (CTO), tall oil pitch (TOP), crude fatty acid (CFA), tall oil fatty acid (TOFA) and distilled tall oil (DTO); microbial oils; algal oils; recycled fats or various waste streams of the food industry, such as used cooking oil, yellow and brown greases; free fatty acids, any lipids containing phosphorous and/or metals, oils originating from yeast or mold products, recycled alimentary fats; starting materials produced by genetic engineering, and any mixtures of said feedstocks.

In one embodiment of the current invention the feedstock comprising organic material of biological origin comprise pitch containing crude tall oil (CTO), residue and waste oils from palm oil production and/or recycled fats and oils.

In an embodiment of the present invention organic material of biological origin used as feedstock is selected from a group consisting of crude tall oil (CTO), tall oil pitch (TOP), tall oil fatty acid (TOFA), crude fatty acid (CFA) and distilled tall oil (DTO); more particularly the organic material of biological origin is crude tall oil (CTO) or tall oil pitch (TOP).

In addition or as an alternative, the organic material of biological origin can also be selected from acid oils, such as acidulated soapstock (ASK), technical corn oil (TCO), plant oil from plants of the family Brassicaceae (carinata oil), palm effluent sludge (PES), used cooking oil (UCO), gutter oil and brown grease (BG).

As defined herein crude tall oil (CTO, CAS Registry Number 8002-26-4) is most frequently obtained as a by-product of either Kraft or Sulphite pulping processes and tall oil pitch (TOP, CAS number of 8016-81-7) is the residual bottom fraction from crude tall oil distillation processes.

Crude tall oil comprises resin acids, fatty acids, and unsaponifiables. Resin acids are a mixture of organic acids derived from oxidation and polymerization reactions of terpenes. The main resin acid in crude tall oil is abietic acid but abietic derivatives and other acids, such as pimaric acid are also found. Fatty acids are long chain monocarboxylic acids and are found in hardwoods and softwoods. The main fatty acids in crude tall oil are oleic, linoleic and palmitic acids. Unsaponifiables cannot be turned into soaps as they are neutral compounds which do not react with sodium hydroxide to form salts. They include sterols, higher alcohols and hydrocarbons. Sterols are steroids derivatives which also include a hydroxyl group.

Tall oil pitch (TOP) can be considered to be a UVCB substance (Substances of Unknown or Variable composition, Complex reaction product or Biological materials) under the REACH definition. Composition of TOP according to Holmbom (1978) is presented in Table 1. Tall oil pitch typically comprises from 34 to 51 wt. % free acids, from 23 to 37 wt. % esterified acids, and from 25 to 34 wt. % unsaponifiable neutral compounds of the total weight of the tall oil pitch. The free acids are typically selected from a group consisting of dehydroabietic acid, abietic and other resin acids. The esterified acids are typically selected from a group consisting of oleic and linoleic acids. The unsaponifiables neutral compounds are typically selected from a group consisting of diterpene sterols, fatty alcohols, sterols, and dehydrated sterols.

TABLE 1
Component Group Composition of Tall Oil Pitch (wt. % of pitch)^{a}

| Constituents | A | B | C | D | E | F |
|---|---|---|---|---|---|---|
| Free acids, total | 39.3 | 52.6 | 48.6 | 44.6 | 46.7 | 34.6 |
| Fatty acids | 1.4 | 1.8 | 1.3 | 0.8 | 1.3 | 2.4 |
| Resin acids | 10.6 | 12.5 | 9.7 | 6.1 | 3.3 | 6.5 |
| Other acids | 27.3 | 37.3 | 37.3 | 37.7 | 42.1 | 25.7 |
| Esterified acids, total | 30.6 | 23.2 | 23.3 | 26.8 | 27.9 | 37.8 |
| Fatty acids | 8.2 | 12.9 | 13.3 | 15.2 | 13.8 | 12.4 |
| Resin acids | 1.7 | 0.9 | 1.2 | 0.9 | 1.6 | 1.9 |
| Other acids | 20.7 | 9.4 | 8.8 | 10.7 | 12.5 | 23.5 |
| Equiv. weight for free | 648 | 591 | 716 | 642 | 873 | 719 |
| acids | | | | | | |

^{a}Holmbom B, and Erä V, 1978. Composition of Tall oil pitch, Journal of the American oil chemistry society, 55, pp. 342-344.

The term “crude fatty acid (CFA)” refers to fatty acid-containing materials obtainable by purification (e.g., distillation under reduced pressure, extraction, and/or crystallization) of CTO. The term “tall oil fatty acid (TOFA)” refers to fatty acid rich fraction of crude tall oil (CTO) distillation processes. TOFA typically comprises mainly fatty acids, typically at least 80 wt. % of the total weight of the TOFA. Typically, TOFA comprises less than 10 wt. % rosin acids.

The term “distilled tall oil (DTO)” refers to resin acid rich fraction of crude tall oil (CTO) distillation processes. DTO typically comprises mainly fatty acids, typically from 55 to 90 wt. %, and rosin acids, typically from 10 to 40 wt. % rosin acids, of the total weight of the DTO. Typically, DTO comprises less than 10 wt. % unsaponifiable neutral compounds of the total weight of the distilled tall oil.

Acid oils refers to by-products of alkali or physical refining of crude oils and fats. One example of acid oils are oils obtained by acidulation of soapstock (ASK), which contains free fatty acids, acylglycerols and other lipophilic compounds.

The term “technical corn oil” TCO refers to corn oil extracted through a dry milling process. In the dry milling process, corn grains are cleaned and ground directly to obtain a fine corn flour. This flour is then mixed with water, enzymes and other ingredients (cooking and liquefaction) to convert starch into simple sugars, then into glucose (saccharification). This glucose is fermented to produce ethanol, which is then removed by distillation and purified by dehydration. The remaining stillage (called distillers grain) is then processed further to expel technical corn oil (generally called “distillers corn oil” in the United States) through centrifugation. De-emulsifiers can be used to enhance separation of the TCO from the rest of the stillage.

The organic material can also comprise plant oil originating from a plant of the family Brassicaceae (carinata oil). The plant of the family Brassicaceae is selected from Brassica juncea (brown mustard), Brassica carinata (Ethiopian mustard), Brassica nigra (black mustard), Brassica rapa, Brassica rapa subsp. oleifera (field mustard), Brassica elongate (elongated mustard), Brassica nariosa (broadbaked mustard), Brassica rupestris (brown mustard), Brassica tournefortii (Asian mustard), Brassica napus, Brassica napus el, Sinapis hirta (mustard), Sinapis alba (white mustard), Sinapis arvensis, Nasturtium floridanum, Nasturtium gambellium, Nasturtium gronlandicum, Nasturtium microfullum, nasturtium officinale, Nasturtium sordidum and combinations thereof. Preferably the plant is Brassica carinata.

The term “palm effluent sludge” (PES), also commonly referred to, as palm oil mill effluent (POME) here refers to the voluminous liquid waste that comes from the sterilisation and clarification processes in milling oil palm. The raw effluent contains 90-95% water and includes residual oil, soil particles and suspended solids.

The term “used cooking oil” (UCO) refers to oils and fats that have been used for cooking or frying in the food processing industry, restaurants, fast foods and at consumer level, in households.

Gutter oil is a general term for oil that has been recycled. It can be used to describe the practice of restaurants re-using cooking oil that has already been fried before.

Brown grease (BG) means an emulsion of fat, oil, grease, solids, and water separated from wastewater in a grease interceptor (grease trap) and collected for use as feedstock.

In one embodiment the organic material of biological origin comprises crude tall oil (CTO) optionally including tall oil pitch (TOP), tall oil pitch (TOP), brown grease (BG), acidulated soapstock (ASK), technical corn oil (TCO), low quality animal fat (AF), Brassica carinata (BC), palm effluent sludge (PES) or any combination thereof. In one embodiment the feedstock comprises crude tall oil (CTO), tall oil pitch (TOP), brown grease (BG) and acidulated soapstock (ASK).

In one embodiment of the present invention at least one impurity selected from nitrogen, silicon, phosphorous, chloride and metals, is present in the feedstock prior to pre-treatment in high amount, such as for nitrogen over 1000 ppm, silicon over 100 ppm, phosphorous over 700 ppm, chloride over 60 ppm or metals over 4000 ppm.

In one embodiment the feedstock comprising organic material of biological origin comprises crude tall oil (CTO) and/or tall oil pitch (TOP). In one embodiment the feedstock comprising organic material of biological origin comprises resin acids from 10 wt. % to 30 wt. %, based on the total feedstock.

In one embodiment the feedstock to be subjected to the pre-hydrotreatment step contains only organic material of biological origin. Organic material of biological origin is a material which does not contain any fossil or petroleum derived components and contain completely renewable material.

The present process comprises subjecting said feedstock to pre-hydrotreatment, wherein the pre-hydrotreatment is carried out in an ebullated bed reactor, to obtain a partly hydrotreated feed.

An ebullated bed reactor is essentially a continuously stirred reactor, meaning that some unreacted products will always pass through to the product. Ebullated bed reactors are well known for the person skilled in the art. Therefore, the conditions and designs for an ebullated bed reactor is known and can be optimised by the skilled person. An example of an ebullated bed reactor is presented in publication US 2017/0341046.

In an embodiment of the invention the feedstock is introduced to the ebullated bed at the bottom of the reactor or bottom-part of the reactor. The feedstock can be introduced below the catalyst support grid. The ebullated bed contains a grid on which the hydrotreating catalyst is placed. The feedstock together with the treating gas (hydrogen) moves upwards in the reactor through the grid with the catalyst. This upwards movement fluidizes the catalyst bed and at the same time expanding the size of the catalyst bed. The feedstock is effectively mixed with the catalyst together with the treating gas (hydrogen) in the fluidized bed, which enables the reactions to take place. The reagents and reaction product continues to move upwards in the reactor and reaction product is subsequently drawn of the reactor top.

An advantage of using an ebullated bed is that although the catalyst is supported on a grid, the fluidization of the catalyst bed decreases plugging of the catalyst bed due to catalyst fouling. The catalyst of an ebullated bed can also be removed and replenished continuously during operation, enabling continuous removal of spent catalyst (due to deactivation or fouling) and addition of fresh catalyst. This is especially advantageous when the feedstock is of low quality and contains high amounts of impurities.

The purpose of using a pre-hydrotreatment in an ebullated bed reactor is not to achieve full conversion of feed to products, but to act as a guard before subsequent hydrotreatment. The pre-hydrotreatment is performed in the ebullated bed, such that it removes all impurities, which may remain in the feedstock after possible pre-treatment and at least partly removes heteroatoms, such as oxygen, nitrogen, phosphorus and sulfur from the feedstock to obtain a partly hydrotreated feed. The term “partly” here means that the removal of heteroatoms is incomplete, in that all heteroatoms have not been removed. The incomplete removal of heteroatoms means that none of the heteroatoms (N, O, S or P) has been removed complete or at least one of the heteroatoms have not been removed completely, for example oxygen is removed completely but some nitrogen remains. In an embodiment of the invention the pre-hydrotreatment step removes about 80% of oxygen, such as about 90% of oxygen or about 95% of oxygen; about 60% of nitrogen, such as about 70% of nitrogen or about 80% of nitrogen. The completeness and rate of the removal of heteroatoms can be controlled by adjusting the conditions in which the pre-hydrotreatment is performed in the ebullated bed, such as adjusting temperature, pressure, retention time by adjusting weight hourly space velocity (WHSV) and/or catalyst.

Hence, this concept contains a hydrotreatment step, after the pre-hydrotreatment, which can perform a majority of the hydrodeoxygenation (HDO), hydrodenitrogenation (HDN) and hydrodesulfurization (HDS) reactions. Alternatively or in addition, the hydrotreatment can act as a polishing reactor, depending on the sizing of the pre-hydrotreatment. The hydrotreatment is performed in a trickle bed reactor capable of high conversion rates.

The upper level of the ebullated bed reactor is monitored by level measurements and controlled by recycle pumping speed. The expanded bed section of the ebullated reactor can optionally be conically shaped, aiding in disengagement of catalyst from the product at the top of the bed, where the linear velocity is lower. Recycle is drawn from above the expanded bed and pumped back through the bottom using an ebullating pump.

The pre-hydrotreatment conditions in the ebullated bed can be as follows: an LHSV of from 0.2 l/h to 4 l/h, a pressure of from 1.5 MPa to 6 MPa, preferably 2.0 MPa to 4.5 MPa, and a temperature of from 260° C. to 400° C., preferably from 280° C. to 350° C.

The present process further comprises subjecting the partly hydrotreated feed to hydrotreatment, wherein the hydrotreatment is carried out in a fixed bed reactor, to obtain a stream of hydrocarbons, and subjecting the stream of hydrocarbons to isomerisation to obtain an isomerised stream of hydrocarbons.

While the pre-hydrotreatment performed in an ebullated bed is not as sensitive to catalyst fouling due to impurities, the ebullated bed is only able to produce a partly hydrotreated feed. The partly hydrotreated feed requires additional hydrotreatment to obtain a stream of hydrocarbons. Especially, some nitrogen containing compounds can remain in the partly hydrotreated feed. In an embodiment of the invention, the partly hydrotreated feed comprises at least 5 wt. %, such as at least 10 wt. % or even 15 wt. % of the nitrogen amount of the feedstock entering the pre-hydrotreatment step. In an embodiment the partly hydrotreated feed also contain aromatic, cyclic and/or high molecular weight compounds boiling above diesel boiling point range, which need to be hydrocracked in the hydrotreatment step. Thereby, the partly hydrotreated feed subjected to hydrotreatment in a fixed bed is different in its chemical composition to the feedstock subjected to the pre-hydrotreatment. Due to the differences in the feeds to pre-hydrotreatment and hydrotreatment, also the pre-hydrotreatment and hydrotreatment conditions can be adjusted individually.

In an embodiment, the conditions for pre-hydrotreatment and hydrotreatment are different from each other, particularly the temperature of hydrotreatment is at least 10° C. higher than in the pre-hydrotreatment.

In one embodiment of the present invention, the hydrotreatment is performed in conditions selected from:
a temperature range of 300° C. to 380° C., preferably of 320° C. to 360° C.;
a pressure range of 40 to 80 bar, preferably 50 to 70 bar;
a weight hourly space velocity (WHSV) of 0.25 l/h to 1.5 l/h, preferably 0.3 l/h to 1 l/h; and
a H₂/oil feed of 800 dm³/dm³ to 1200 dm³/dm³, preferably of 900 dm³/dm³ to 1100 dm³/dm³.

The catalyst used in the hydrotreatment step is a typical hydrotreating catalyst such as Ni, Co, Mo on a carrier such as alumina. Alternatively or in addition, the catalyst in the hydrotreatment can also be a typically hydrocracking catalyst such as NiW on acidic supports (ASA, Zeolites). In one embodiment the catalyst in the hydrotreatment is NiMo on alumina carrier. The treatment step is typically carried out in a reactor with one or more catalyst beds.

In the hydrotreatment step there is typically no recycling or the stream of hydrocarbon withdrawn from the reactor. If there is any recycling in the hydrotreatment step a maximum of 10 wt. % of the stream of hydrocarbons is recycled back to hydrotreatment. In one embodiment the hydrotreatment step does not contain any recycling.

The aim of the hydrotreatment is to essentially remove all impurities and heteroatoms from the feed, and the stream of hydrocarbons should therefore essentially only contain hydrocarbons.

In one embodiment of the current invention, the isomerization of the stream of hydrocarbons to obtain a stream of isomerized hydrocarbons is performed in conditions selected from:
a temperature range of 300° C. to 360° C., preferably 310° C. to 345° C.;
a pressure range of 35 bar to 60 bar, preferably 40 bar to 50 bar;
a weight hourly space velocity (WHSV) of 1 l/h to 1.5 l/h.

The catalyst used in the isomerization of the stream of hydrocarbons is any typical isomerization catalyst, such as Pt or Pd on a suitable support, preferably the isomerization catalyst is Pt-SAPO11.

In one embodiment of the present invention the process further comprises a stripping step to remove gaseous compounds from a stream of the process. The stripping step can be performed after the optional pre-treatment step, the pre-hydrotreatment step in ebullated bed, the hydrotreatment step, the isomerization step or any combination thereof. In one embodiment the stripping is performed after the pre-hydrotreatment step to remove gaseous compounds. Gaseous compounds which can be removed in a stripping step include sulphide (H₂S), ammonia (NH₃) and water. The stripping step can also be called a flash step or flash evaporation or flash distillation.

In one embodiment the process further comprises a pre-treatment step, wherein the feedstock comprising organic material is purified from impurities such as metals, halogens, phosphorus and/or silicon to obtain a purified feedstock. If present, the pre-treatment step is performed prior to the pre-hydrotreatment step and the purified feedstock is subjected to the pre-hydrotreatment step. In one embodiment the process does not comprise a pre-treatment or purification step, but the feedstock comprising organic material is fed directly to the pre-hydrotreatment in an ebullated bed reactor, which then also functions as a pre-treatment or purification step for the feedstock.

If pre-treatment is performed, in one embodiment the pre-treatment stage comprises heat treatment (HT) optionally followed by evaporation of volatiles; heat treatment with adsorbent (HTA) optionally followed by evaporation; degumming; bleaching or any combination thereof.

In one embodiment the pre-treatment is selected from heat treatment optionally followed by evaporation of volatiles, whereby the feedstock is heated at a temperature of from 80° C. to 325° C., preferably 180° C. to 300° C., more preferably 200° C. to 280° C., in a residence time from 1 to 300 min. The heat treatment can be followed by an evaporation step, where especially silicon and phosphorus containing compounds are removed. An example of heat treatment of a feedstock comprising organic material can be found in WO 2020/016405. Heat treatment can also be followed by filtration as an addition or an alternative to evaporation. When the feedstock comprises brown grease or acidulated soapstock the pre-treatment comprising heat treatment with or without filter-aid (adsorbent) followed by filtration and possible bleaching.

In one embodiment the pre-treatment is selected from heat treatment with adsorbent (HTA) optionally followed by flash evaporation. HTA as pre-treatment is especially suitable when the feedstock comprises CTO and/or TOP, but also for other feedstock. Heat treatment with adsorbent (HTA) can be performed in a temperature from 180° C. to 325° C., preferably from 200° C. to 300° C., more preferably from 240° C. to 280° C., optionally in the presence of an acid. The adsorbent can be selected from alumina silicate, silica gel and mixtures thereof and is typically added in an amount of 0.1 wt. % to 10 wt. %, such as 0.5 wt. %. An example of HTA can be found in WO 2020/016410.

In one embodiment of the present invention the feedstock of the invention comprises an impurity level of
nitrogen compounds from more than 30 ppm, preferably more than 50 ppm or 100 ppm, such as up to 5000 ppm;
silicon compounds from more than 1 ppm, preferably more than 5 ppm or more than 10 ppm or 30 ppm, up to 500 ppm;
phosphorous compounds from more than 5 ppm, preferably more than 10 ppm or 50 ppm, up to 3500 ppm;
chloride from more than 1 ppm, preferably more than 5 ppm or 10 ppm, up to 300 ppm; and/or
metals from more than 10 ppm, preferably more than 30 ppm or 50 ppm, up to 20000 ppm.

The amount of metals are given as the total sum of at least Ca, Mg, Na and Fe.

In one embodiment of the present invention at least one impurity selected from nitrogen, silicon, phosphorous, chloride and metals, is present in the feedstock prior to pre-treatment in high amount, such as for nitrogen over 1000 ppm, silicon over 100 ppm, phosphorous over 700 ppm, chloride over 60 ppm or metals over 4000 ppm.

The present process can further comprise distilling one or more streams of the process, to obtain at least two fractions, a first heavy bottom fraction, which is removed from the process and a second middle fraction, which is collected and/or subjected to further process steps.

In an embodiment of the invention a distillation is performed after the pre-hydrotreatment step and before the hydrotreatment step. If the distillation is performed before the hydrotreatment step, the middle fraction is subjected to hydrotreatment according to the invention.

In another embodiment a distillation is performed after the hydrotreatment step and before the isomerisation. In an embodiment a distillation is performed after the isomerisation step.

The distillation, if present, produces at least two fractions, which are a first heavy bottom fraction and a second middle fraction. The first heavy bottom fraction is typically removed from the present process and the middle fraction is collected and subjected to further treatments. The first heavy bottom fraction can be characterized such that at least 90% of the components (compounds) of the first heavy bottom fraction have a boiling point of 360° C. or above. The second middle fraction can be characterized such that at least 90% of the components (compounds) of the second middle fraction have a boiling point of from 180° C. to 360° C. All boiling points are given in atmospheric pressure. The first heavy bottom fraction can be used as a product as such or subjected to other processes (not disclosed here).

In one embodiment of the present invention the distillation is performed using the following conditions: a cut point target of 340° C. to 360° C., vacuum set point of 2 mbar, top column temperature of 180° C., nitrogen feed rate of 2 l/h and feed rate of 0.24 l/h. These conditions are to be regarded as examples and a skilled person is able to operate the distillation such that the target fractions are obtained.

It will be obvious to a person skilled in the art that, as the technology advances, the inventive concept can be implemented in various ways. The invention and its embodiments are not limited to the examples described above but may vary within the scope of the claims.

1-11. (canceled)

12. A process for producing hydrocarbons from a feedstock containing organic material of biological origin, the process comprising:
a) providing a feedstock containing organic material of biological origin;
b) subjecting said feedstock to pre-hydrotreatment, wherein the pre-hydrotreatment is carried out in an ebullated bed reactor, to obtain a partly hydrotreated feed;
c) subjecting the partly hydrotreated feed to hydrotreatment, wherein the hydrotreatment is carried out in a fixed bed reactor, to obtain a stream of hydrocarbons; and
d) subjecting the stream of hydrocarbons to isomerisation to obtain an isomerised stream of hydrocarbons.

13. The process of claim 12, comprising:
a pre-treatment step, wherein the feedstock containing organic material is purified to obtain a purified feedstock, and the purified feedstock is subjected to the pre-hydrotreatment of step b).

14. The process of claim 12, comprising:
distilling one or more streams of the process, to obtain at least two fractions, a first heavy bottom fraction which is removed from the process, and a second middle fraction which is collected and/or subjected to further process steps.

15. The process of claim 12, wherein the feedstock containing organic material of biological origin comprises at least one or more of:
crude tall oil (CTO), tall oil pitch (TOP), tall oil fatty acid (TOFA), crude fatty acid (CFA), distilled tall oil (DTO), acid oils, acidulated soapstock (ASK), technical corn oil (TCO), plant oil from plants of the family Brassicaceae (carinata oil), palm effluent sludge (PES), used cooking oil (UCO), gutter oil, brown grease (BG) and/or any combination thereof.

16. The process of claim 12, wherein the feedstock comprises:
crude tall oil (CTO) and/or tall oil pitch (TOP).

17. The process of claim 12, wherein the feedstock comprises:
resin acids from 10 wt. % to 30 wt. %, based on a total weight of the feedstock.

18. The process of claim 12, wherein the feedstock containing organic material of biological origin comprises at least one or more of:
an impurity level of nitrogen compounds from more than 30 ppm, up to 5000 ppm;
silicon compounds from more than 1 ppm or 5 ppm, up to 500 ppm;
phosphorous compounds from more than 5 ppm, up to 3500 ppm;
chloride from more than 1 ppm or 5 ppm, up to 300 ppm; and/or
metals from more than 10 ppm or 30 ppm, up to 20000 ppm.

19. The process of claim 12, wherein the pre-hydrotreatment of the feedstock of step b) is carried out at a temperature of from 260° C. to 400° C., and/or from 280° C. to 350° C.; a pressure of from 1.5 MPa to 6 MPa, and/or 2.0 MPa to 4.5 MPa; and an LHSV of from 0.2 l/h to 4 l/h.

20. The process of claim 12, wherein the hydrotreatment of the partly hydrotreated feed of step c) is carried out at a temperature of 300° C. to 380° C.; a pressure of 40 bar to 80 bar; a WHSV of 0.25 l/h to 1.5 l/h; and in a presence of a hydrotreatment and/or hydrocracking catalyst, selected from Ni, Co, Mo and/or W, on a carrier optionally formed of alumina.

21. The process of claim 12, wherein the isomerization of the stream of hydrocarbons of step d) is carried out at a temperature of 300° C. to 360° C., and/or 310° C. to 345° C.; a pressure of 35 bar to 60 bar; WHSV of 1.0 l/h to 1.5 l/h; and in a presence of an isomerising catalyst selected from supported Pt or Pd catalyst, and/or a Pt-SAPO11 catalyst.

22. The process of claim 12, comprising:
a distillation step, optionally performed after the pre-hydrotreatment step and before the hydrotreatment step.

23. The process of claim 13, comprising:
distilling one or more streams of the process, to obtain at least two fractions, a first heavy bottom fraction which is removed from the process, and a second middle fraction which is collected and/or subjected to further process steps.

24. The process of claim 23, wherein the pre-hydrotreatment of the feedstock of step b) is carried out at a temperature of from 260° C. to 400° C., and/or from 280° C. to 350° C.; a pressure of from 1.5 MPa to 6 MPa, and/or 2.0 MPa to 4.5 MPa; and an LHSV of from 0.2 l/h to 4 l/h.

25. The process of claim 24, wherein the hydrotreatment of the partly hydrotreated feed of step c) is carried out at a temperature of 300° C. to 380° C.; a pressure of 40 bar to 80 bar; a WHSV of 0.25 l/h to 1.5 l/h; and in a presence of a hydrotreatment and/or hydrocracking catalyst, selected from Ni, Co, Mo and/or W, on a carrier optionally formed of alumina.

26. The process of claim 25, wherein the isomerization of the stream of hydrocarbons of step d) is carried out at a temperature of 300° C. to 360° C., and/or 310° C. to 345° C.; a pressure of 35 bar to 60 bar; WHSV of 1.0 l/h to 1.5 l/h; and in a presence of an isomerising catalyst selected from supported Pt or Pd catalyst, and/or a Pt-SAPO11 catalyst.

27. The process of claim 26, comprising:
a distillation step, optionally performed after the pre-hydrotreatment step and before the hydrotreatment step.

28. The process of claim 27, comprising:
a distillation step, optionally performed after the pre-hydrotreatment step and before the hydrotreatment step.
